(19) United States
(12) Patent Application Publication
(10) Pub. No.: US 2013/0257046 A1
(43) Pub. Date: Oct. 3, 2013

(54) CONNECTION ARRANGEMENT FOR A CONED FLANGE CONNECTION AND CONED FLANGE CONNECTION

(71) Applicant: NORMA GERMANY GMBH, Maintal (DE)

(72) Inventors: Detlef HENRICH, Limeshain (DE); Mathias KRAUSS, Nidderau (DE); Thomas LEGEL, Rodgau (DE); Stephan MANN, Bieber (DE); Manfred KRUEGER, Buedingen (DE)

(73) Assignee: NORMA GERMANY GMBH, Maintal (DE)

(21) Appl. No.: 13/828,098

(22) Filed: Mar. 14, 2013

(30) Foreign Application Priority Data
Apr. 3, 2012 (DE) 10 2012 006 756.9

(51) Int. Cl. F16L 23/04

(52) U.S. Cl. CPC F16L 23/04
USPC 285/407

(57) ABSTRACT

A connection arrangement for a coned flange connection and coned flange connection. The connection arrangement includes a tensioning device bent in a ring shape having a changeable inner diameter, legs projecting radially inwardly from the tensioning device and forming, in an axial direction, an accommodation space, and an insert on which the legs are formed being arranged inside the tensioning device. The insert has a back bearing against an inside of the tensioning device and is arranged to connect the legs. The legs have multiple gaps in a circumferential direction.

### CROSS-REFERENCE TO RELATED APPLICATIONS

The present application claims priority under 35 U.S.C. §119 of German Patent Application No. 102012006756.9, filed Apr. 3, 2012, the disclosure of which is expressly incorporated by reference herein in its entirety.

### BACKGROUND OF THE EMBODIMENTS

1. Field of the Invention

Embodiments of the invention relate to a connection arrangement for a coned flange connection with a tensioning device bent in a ring shape having a changeable inner diameter and legs protruding radially inwardly from the tensioning device to form, in an axial direction between the legs, an accommodation space.

Furthermore, the invention relates to a coned flange connection with a connection arrangement of this type.

2. Discussion of Background Information

A coned flange connection serves to connect two component parts with one another, for example two pipes.

For this purpose, each component part has on the end on which the connection should occur a flange protruding radially outwards, which on its back side facing away from the free end of the component part is beveled. The connection arrangement is often embodied as a so-called profile clamp, in which the legs projecting radially inwards are sloped corresponding to the slope angle of the coned flange. When the profile clamp is tightened such that its inner diameter is decreased, then the legs press the coned flanges together in an axial direction.

A profile clamp of this type is for example known from DE 198 18 562 C1, the disclosure of which is expressly incorporated by reference herein in its entirety.

A profile clamp of this type has indeed proven itself. It requires however relatively narrow tolerances both on the coned flanges and also on the cross section of the profile clamp. This renders it practically impossible to use the same profile clamp for different diameters of the component parts that are to be connected. Even small differences in the range of 1 or 2 mm can practically no longer be absorbed by a profile clamp. Thus, for each diameter of the component parts that are to be connected, a separate profile clamp is required. Moreover, to produce a profile clamp of this type a corresponding tool is necessary. Consequently, the more tools necessary, the higher the costs for the production of the profile clamps and thus also for the coned flange connection.

### SUMMARY OF THE EMBODIMENTS

Embodiments of the invention are directed to a cost-effective coned flange connection.

In this regard, a connection arrangement of the type named at the outset includes an insert, on which the legs are embodied or formed, that is arranged inside the tensioning device. The insert has a back that connects the legs and that bears against an inside of the tensioning device. The legs, in a circumferential direction, include multiple gaps.

A connection arrangement of this type can be manufactured at low cost. The legs are arranged on an insert, and the insert can be made from one band, that is, virtually endlessly. On this band, only the legs must be bent back. This takes place expediently after the insertion of the gaps. It is then possible to cut the band to length and form the insert by bending the band in a ring shape such that it fits into the tensioning device. Between the ends of the insert, a larger distance can thereby definitely be present, as long as the connection arrangement is not yet tightened. If, when tightening the tensioning device, the inner diameter of the tensioning device is decreased, then the ends of the insert will draw closer to one another. The legs will then act on the coned flanges of the component parts to be connected and connect them. Because the same band can be used for connection arrangements that are provided for different nominal diameters, production costs are considerably reduced. For different nominal diameters, the band forming the insert only needs to be embodied of formed with different lengths. However, the same band can be used for different connection arrangements. Expediently, the gaps are respectively arranged with a division selected such that defined diameter steps can be achieved. These diameter steps can for example correspond to a standardized series.

Preferably, the legs are arranged springably on the back. When the tensioning device is tightened onto the coned flanges, the legs are pressed apart from one another, such that a spring force is then produced which presses the coned flanges together. This spring force can be influenced by the choice of the material of the legs and the choice of the geometry of the legs.

Preferably, the gaps have radially outside a rounded-off bottom. Sharp corners are thereby avoided on which the band forming the insert could tear. Due to the rounded-off bottom, the insert can rather be twisted, such that a certain bending resistance is definitely present. However, because of the gaps, this bending resistance is manageable, such that the tightening of the tensioning device is also possible by human force without additional assistance.

Preferably, the back has a curvature in cross section, and this curvature allows a certain prestress, by which the legs can be loaded inwardly in an axial direction. Therefore, in contrast to the known art, the legs no longer need to have a slope which corresponds to the slope of the coned flanges. Instead it is sufficient if they move along the coned flanges with their edges. The curvature of the back then produces a tension force which is sufficient to hold the coned flanges together.

Preferably, the insert is attached to the tensioning device, and at least one end of the insert is movable with respect to the tensioning device. The attachment of the insert to the tensioning device can occur, e.g., through a welding point or the like. If at least one end of the insert is moveable with respect to the tensioning device, then it is possible, despite the attachment of the insert to the tensioning device, to tighten the tensioning device and decrease its inner diameter. The insert is unloseably held in the tensioning device.

Preferably, the legs have edge sections which project into the accommodation space. The edge sections thereby bear against the coned flanges when the connection arrangement is used. Therefore, narrow tolerances no longer need to be considered in order to have the legs bear in a planar manner against the coned flanges. The contact between the coned flanges and the legs occurs instead along a line.

It is also advantageous if at least one edge section has a rounded end. This simplifies assembly. A rounded end can be produced easily, e.g., by bending.

Here, it is preferable that the edge sections of the legs, which axially face one another, are arranged in the same radial position. Tilting moments onto the coned flanges are thereby avoided. In a circumferential direction, an offset is permissible.

Preferably, the edge sections have respectively sliding surfaces which are sloped to the radial direction of the tensioning device. The tightening is thereby facilitated. The edge sections can slide along the coned lateral areas radially inwards without increased friction occurring. During this sliding, the edge sections are spread away from one another. The stronger the spreading is, the greater the springback force is which holds the coned flanges together axially.

Preferably, the legs in cross section have a curvature which when viewed from the accommodation space is embodied concavely. This has two different results. In particular, it is ensured that only the edge sections bear against the coned flanges, so that remainders of the legs do not come into contact with the coned flanges. Further, with a curvature of this type, the prestress of the legs can be embodied or formed to be great enough so that the desired retention forces can be applied to the coned flanges.

It is particularly advantageous that the insert in cross section has a C-shaped or an Ω-shaped curvature. However, it is understood that these terms of shape are general and should be broadly construed. The insert is overall concavely embodied, e.g., rounded. However, the insert can also have flat surfaces, e.g., in a fitting area on the tensioning device. With this configuration of the cross-section, in particular with the curvature of the cross-section overall, a desired prestress can be adjusted which later produces the desired retention force.

Preferably, the tensioning device is embodied or formed as a worm drive clamp. A worm drive clamp renders it possible to span relatively large diameter differences. When the tensioning device is opened, i.e., when the worm drive clamp is provided with its largest diameter, it is possible to guide the legs past the coned flanges. Subsequently, the diameter of the worm drive clamp can be decreased until the desired tension force is achieved.

Embodiments of the invention are solved for a coned flange connection in that a connection arrangement is used such as the connection arrangement that has been described above.

In particular, it is preferable that the coned flanges have in a radial direction a height which is greater than the radial extension of the insert. In this manner, it is possible to bring the insert to bear on the radially outside areas of the coned flanges and at the same time to ensure that the radially inside ends of the legs still bear on the coned lateral areas. If the tensioning device is tightened so far that the back of the insert bears on the perimeter of the coned flanges, then there is automatically a limitation which indicates that the end of the tightening process is reached. A visual assembly inspection is possible.

Embodiments of the invention are directed to a connection arrangement for a coned flange connection. The connection arrangement includes a tensioning device bent in a ring shape having a changeable inner diameter, legs projecting radially inwardly from the tensioning device and forming, in an axial direction, an accommodation space, and an insert on which the legs are formed being arranged inside the tensioning device. The insert has a back bearing against an inside of the tensioning device and is arranged to connect the legs. The legs have multiple gaps in a circumferential direction.

According to embodiments, the legs can be springably arranged on the back.

In accordance with embodiments of the invention, the gaps can have rounded-off bottoms on radially outer ends.

In embodiments, the back in a cross-section has a curvature.

Further, the insert can be attached to the tensioning device and at least one end of the insert cab be movable with respect to the tensioning device.

In other embodiments of the instant invention, the legs may have edge sections which project into the accommodation space. At least one of the edge sections can have a rounded end.

According to still other embodiments, the edge sections of the legs may axially face one another and can be arranged in a same radial position.

Moreover, the edge sections can have respective sliding surfaces oriented to be sloped relative to the radial direction of the tensioning device.

In other embodiments of the invention, the legs, when viewed from the accommodation space, may have a concave shape. In cross-section, the insert can have a C-shaped or Ω-shaped curvature.

Further, the tensioning device may include as a worm drive clamp.

Embodiments of the invention are directed to a coned flange connection that includes coned flanges formed on two component parts to be connected together, and the above-described connection arrangement.

In accordance with embodiments, the coned flanges can have a radial height that is greater than the radial extension of the legs.

Further, the connection arrangement may be positioned over the coned flanges.

Embodiments of the instant invention are directed to a connection arrangement for a coned flange connection. The connection arrangement includes a tensioning band having an adjustable inner diameter, an insert coupled to the tensioning band and having a back with springably attached radially extending legs, and curved sections located on the legs positioned to engage coned flanges to be connected.

According to embodiments of the invention, the legs have multiple gaps in a circumferential direction.

In other embodiments, at least one of the back and the legs can have straight sections.

Moreover, the curved sections can be curved in opposite directions.

In accordance with still yet other embodiments of the present invention, the curved sections are curved in a same direction.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 schematically illustrates a coned flange connection;

FIG. 2 schematically illustrates a side view of the coned flange connection;

FIG. 3 schematically illustrates a front view of the coned flange connection;

FIG. 4 schematically illustrates a top view of the coned flange connection;

FIG. 5 schematically illustrates a perspective representation of the coned flange connection;

FIG. 6 schematically illustrates an embodiment of an insert modified from FIG. 1;

FIG. 7 schematically illustrates an additional modification of an insert;

FIG. 8 schematically illustrates a modified embodiment of an insert depicted in FIG. 7;

FIG. 9 schematically illustrates a modified embodiment of an insert; and

FIG. 10 schematically illustrates an additional modification of an insert.

### DETAILED DESCRIPTION OF THE EMBODIMENTS OF THE INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

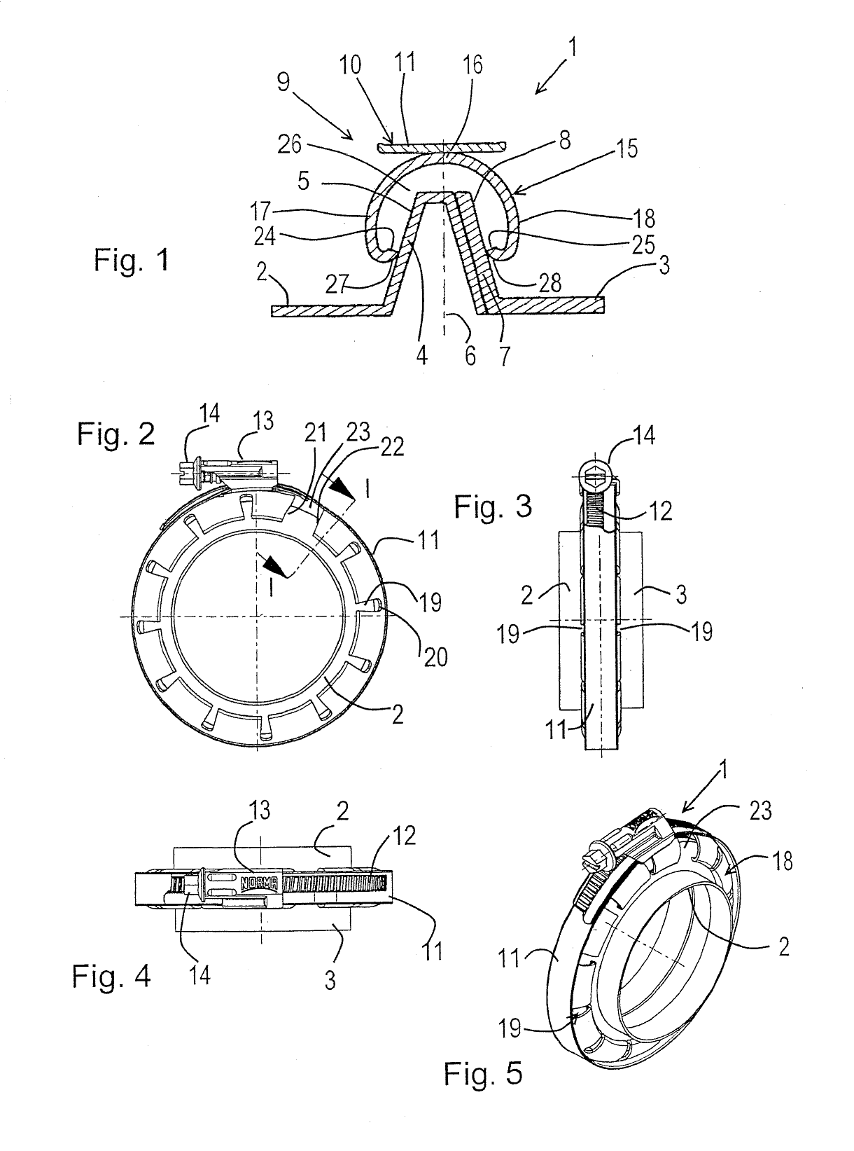

FIG. 1 illustrates a schematic representation of a cut through a part of a coned flange connection 1. The coned flange connection serves to connect a first component part 2, e.g., a pipe, with a second component part 3, e.g., a connecting piece. For this purpose, first component part 2 has a radially outward-pointing projection 4, which on its outside 5 facing away from the second component part 3 has a slope relative to a radial direction 6. Second component part 3 likewise has a radially outward directed projection 7, which on its outside 8 facing away from the first component part 2 is sloped in relation to radial direction 6. In principle, it is sufficient if one of the two outsides 5 and 8 is sloped or beveled.

A connection arrangement 9 has a tensioning device 10 bent in a ring shape, which can be embodied or formed as a worm drive clamp, as shown in FIGS. 2-4. Tensioning device 10 has for this purpose a tensioning band 11, which in the area of one end is provided with a thread track 12 and in the area of the other end with a tensioning head 13. In the tensioning head 13, a tensioning screw 14 is arranged to engage with the thread track. By turning the tensioning screw 14, the inner diameter of the tensioning device 10, more precisely, the inner diameter of the tensioning band 11, can be changed.

An insert 15 with a C-shaped form in cross-section is arranged inside the tensioning device 10. Expediently, insert 15 is connected in an area in a circumferential direction with the tensioning band 11 by, e.g., one or several welding points, riveting, mechanical bonding, insetting or a bracket attachment. Insert 15 is thereby unloseably or fixedly held inside the tensioning device. However, it has at least one end that can move with respect to the tensioning device 10 in a circumferential direction when the tensioning device 10 is tightened and decreases its inner diameter.

Insert 15 has a back 16 which is connected to the tensioning band 11. From the back 16, two legs 17 and 18 extend inwards in radial direction 6 and branch off in an axial direction on both sides. As can be particularly recognized from FIG. 2, each leg, in a circumferential direction, has multiple gaps 19 that have, on their radial outsides, rounded-off bottoms 20. Bottoms 20 can also have other forms, e.g., trapezoidal.

As can be recognized in FIG. 2, insert 15 has two ends 21 and 22, between which a distance 23 is provided. This distance 23 has a minimum when tensioning device 10 is tightened. When the tensioning device 10 is completely released, the distance 23 has a maximum. In this state, legs 17 and 18 have on their radial inside a diameter which allows the connection arrangement 9 to be guided past projections 4 and 7.

The leg 17 has on its radial inside an edge section 24. The leg 18 has on its radial inside an edge section 25. The two edge sections 24 and 25 are respectively curved inwards, thus projecting into an accommodation space 26 which is embodied between the legs 17 and 18.

The two edge sections 24 and 25 have sliding surfaces 27 and 28 which are sloped to the radial direction 6. It is thereby possible that the sliding surfaces 27 and 28 can slide on the outsides 5 and 8 of the projections 4 and 7 without catching there. The edge sections 24 and 25 are roundly curved.

The legs 17 and 18 are springably connected to the back 16 or insert 15 is overall springably embodied. When the tensioning device 10 is tightened, the legs 17 and 18 are pressed apart from one another and act with a spring force on the projections 4 and 7. Tolerances can thereby be compensated, e.g., for diameter differences or for different axial distances of the outsides 5 and 8.

The distance between the edge sections 24 and 25 and the back 16 in a radial direction is less than the extension of projections 4 and 7 in a radial direction. Thus, it is possible that the back 16 can be tightened with its radial inside up until bearing on the radial outside of the projections 4 and 7 without edge sections 24 and 25 contacting component parts 2 and 3 axially outside of projections 4 and 7. When back 16 bears against the outer circumference of projections 4 and 7, a further tightening of the tensioning device 10 is no longer possible. A technician who assembles the connection arrangement 9 at the coned flange connection 1 notices a clear increase of the tension force and knows then that he has sufficiently tightened the connection arrangement.

As can be recognized in FIG. 1, back 16 has a bend or curvature, which merges into the bend or curvature of legs 17 and 18. In this way, it is possible to convey to legs 17 and 18 a prestress, such that they act with a sufficient force on projections 4 and 7 to push these together in an axial direction. This force becomes all the greater the further edge sections 24 and 25 are moved radially inwards, because due to the beveled outsides 5 and 8, a spreading-apart of legs 17, and 18 occurs with increasing radially inward movement. However, this spreading-apart has the advantage that the compliance with narrow tolerances is not depended on. Both projections 4 and 7 and also insert 15 can be manufactured with greater tolerances without compromising the attachment force of connection arrangement 9.

The attachment force of connection arrangement 9 can be adjusted with multiple measures. For example, the distance between gaps 19 in a circumferential direction can be chosen larger or smaller. For a larger distance, a somewhat stronger force is in fact necessary when tightening tensioning device 10. In exchange however legs 17 and 18 can be provided with a higher prestress. A thicker material can also be used for insert 15 which opposes twisting with an increased resistance. This also contributes to increasing the tension force.

Insert 15 can be manufactured relatively easily. For this purpose, a flat band is used into which gaps 19 are first inserted, e.g., by stamping. After this, legs 17 and 18 and edge sections 24 and 25 are bent. As a final work step, the band which has been reshaped in this manner must be “rolled up” in order to produce the ring form that can be recognized in FIG. 2.

Expediently, the two edge sections 24 and 25, which face one another in an axial direction, are arranged in a same radial position. In this way, it is avoided that connection arrangement 9 exerts a tilting moment on projections 4 and 7.

The surfaces of outsides 5 and 8 of projections 4 and 7 can be relatively rough, which further keeps production costs low. The profile geometry from which insert 15 is made can be manufactured virtually endlessly. An adjustment of the profile lengths to the desired diameters is achieved by a corresponding cross-cutting between the segments that later form inserts 15. The configuration of the segment length allows the use for a particular diameter series.

Instead of the illustrated worm drive clamp 10, tension clamps or hinge bolt clamps can naturally also be used. In principle, the use of a spring band clamp is also possible. It is necessary that these clamps permit a diameter change in which legs 17 and 18 can be guided over projections 4 and 7, and can be sufficiently tightened in order to transfer the necessary axial forces between edge sections 24 and 25 to projections 4 and 7.

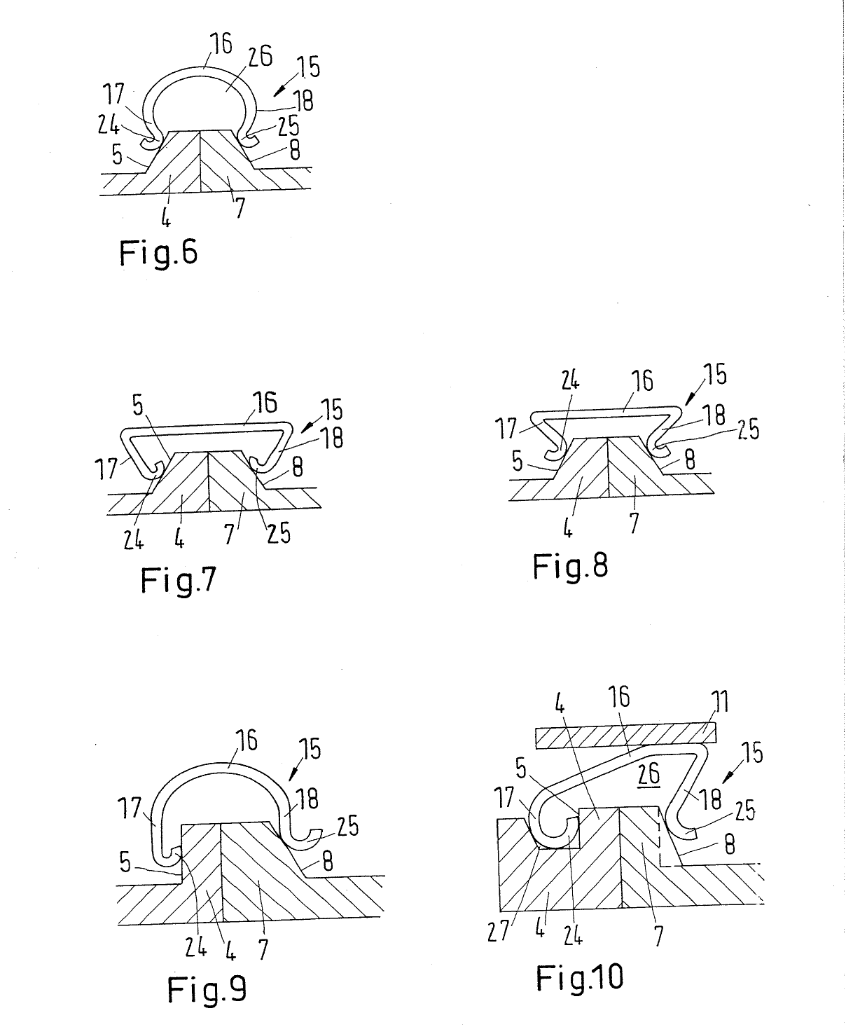

FIGS. 6 through 10 show different possible embodiments of insert 15. The same and functionally similar elements are assigned the same reference numbers as in FIGS. 1 through 5.

FIG. 6 shows an insert 15 in which edge sections 24 and 25 of legs 17 and 18 have an outward curved end. However, edge sections 24 and 25 are still bent into accommodation space 26. Overall, insert 15 has a cross-sectional n shape. Accordingly, an easier sliding of edge sections 24 and 25 on outsides 5 and 8 of projections 4 and 7 can be achieved.

FIG. 7 shows an insert 15 which differs from the insert 15 depicted in FIG. 1 in that back 16 is essentially embodied or formed as a flat surface. Also, legs 17 and 18 are embodied or formed to be essentially flat except for edge sections 24 and 25. A spring effect of legs 17 and 18 towards projections 4 and 7 is then achieved by a suitable material selection.

FIG. 8 shows an embodiment corresponding to FIG. 7 in which a difference exists in that edge sections 24 and 25 again have outwardly curved ends.

FIG. 9 shows an unsymmetrical insert in which one edge section 24 is bent inwardly, while the other edge section 25 is bent outwardly. In this case, only outer wall 8 is provided with a slope. Outer wall 5 is formed to run essentially perpendicularly to the components axes.

FIG. 10 shows a likewise asymmetrically embodied insert 15 in which back 16 has a slight bend and is sloped. Accordingly, tensioning band 11 acts here in an area on insert 15, which is arranged radially outside of leg 18. Leg 17, of which edge section 24 is bent into accommodation space 26, is arranged in a groove 27, that is, it cannot move away from the projection 4.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A connection arrangement for a coned flange connection comprising:
a tensioning device bent in a ring shape having a changeable inner diameter;
legs projecting radially inwardly from the tensioning device and forming, in an axial direction, an accommodation space; and
an insert on which the legs are formed being arranged inside the tensioning device, the insert having a back bearing against an inside of the tensioning device and being arranged to connect the legs;
wherein the legs have multiple gaps in a circumferential direction.

2. The connection arrangement according to claim 1, wherein the legs are springably arranged on the back.

3. The connection arrangement according to claim 1, wherein the gaps have rounded-off bottoms on radially outer ends.

4. The connection arrangement according to claim 1, wherein the back in a cross-section as a curvature.

5. The connection arrangement according to claim 1, wherein the insert is attached to the tensioning device and at least one end of the insert is movable with respect to the tensioning device.

6. The connection arrangement according to claim 1, wherein the legs have edge sections which project into the accommodation space.

7. The connection arrangement according to claim 6, wherein at least one of the edge sections has a rounded end.

8. The connection arrangement according to claim 1, wherein the edge sections of the legs axially face one another and are arranged in a same radial position.

9. The connection arrangement according to claim 1, wherein the edge sections have respective sliding surfaces oriented to be sloped relative to the radial direction of the tensioning device.

10. The connection arrangement according to claim 1, wherein the legs, when viewed from the accommodation space, have a concave shape.

11. The connection arrangement according to claim 10, wherein, in cross-section, the insert has a C-shaped or Ω-shaped curvature.

12. The connection arrangement according to claim 1, wherein the tensioning device comprises as a worm drive clamp.

13. A coned flange connection comprising:
coned flanges formed on two component parts to be connected together; and
the connection arrangement according to claim 1.

14. The coned flange connection according to claim 13, wherein the coned flanges have a radial height that is greater than the radial extension of the legs.

15. The coned flange connection according to claim 13, wherein the connection arrangement is positioned over the coned flanges.

16. A connection arrangement for a coned flange connection comprising:
a tensioning band having an adjustable inner diameter;
an insert coupled to the tensioning band and having a back with springably attached radially extending legs; and
curved sections located on the legs positioned to engage coned flanges to be connected.

17. The connection arrangement according to claim 16, wherein the legs have multiple gaps in a circumferential direction.

18. The connection arrangement according to claim 16, wherein at least one of the back and the legs have straight sections.

19. The connection arrangement according to claim 16, wherein the curved sections are curved in opposite directions.

20. The connection arrangement according to claim 16, wherein the curved sections are curved in a same direction.
